(19) United States
(12) Patent Application Publication
(10) Pub. No.: US 2002/0096156 A1
(43) Pub. Date: Jul. 25, 2002

(54) Multi-speed gear arrangement for a centrifugal engine charger

(76) Inventors: Joseph Palazzolo, Livonia, MI (US); Perry E. Phelan, Harsens Island, MI (US)

Correspondence Address: BRINKS HOFER GILSON & LIONE, P.O. BOX 10395, CHICAGO, IL, 60610, US

(21) Appl. No.: 09/998,259

(22) Filed: Nov. 30, 2001

Related U.S. Application Data
(60) Provisional application No. 60/262,914, filed on Jan. 19, 2001.

(51) Int. Cl. F02B 33/00

(52) U.S. Cl. 123/559.1; 123/561

(57) ABSTRACT

A multi-speed gear arrangement for use in a centrifugal engine charger. A planetary gear set has a ring gear, at least a first and a second set of planetary gears, and at least a first and a second sun gear. A fixed carrier is provided for the planetary gear set, and the planetary gear set has a rotary input and an output that is linked to a rotor of a centrifugal engine charger.

### CLAIM FOR PRIORITY

The present application claims priority to U.S. Provisional Application No. 60/262,914, filed Jan. 19, 2001, entitled “Multi-Speed Centrifugal Supercharger,” and the entire disclosure of U.S. Provisional Application No. 60/262,914 is herein incorporated by reference.

### FIELD OF THE INVENTION

The invention relates generally to the field of internal combustion to engine intake air superchargers and turbochargers. In particular, this invention relates to a multi-speed gear arrangement for supplying variable torque to a centrifugal engine charger.

### DESCRIPTION OF THE RELATED ART

Superchargers, including turbochargers, are added to internal combustion engines to obtain greater power and torque output than would otherwise be available. They compress the air used by the engine which permits greater quantities of fuel to be combusted, thus increasing power and torque. Superchargers are of two basic types; the positive displacement, or “Roots” type, and the turbine, or centrifugal type. Power is required to compress the air, and is supplied by the engine, either by mechanical means such as gears, belts, and chain drive components, or by using the pressurized exhaust gasses to drive a turbine, which drives the supercharger. The latter method is called turbocharging.

Positive displacement superchargers can be driven at a fixed relationship to engine speed and provide the desired power increases. They are relatively large, heavy, inefficient and expensive compared to centrifugal superchargers. The centrifugal supercharger, if driven at a fixed relationship to engine speed, will produce too little power increase at low engine speeds, and have too much pressure available at high engine speeds. The excessive pressure is normally controlled by throttling the inlet stream or by pressure relief valves on the outlet stream. Both of these methods are inefficient, and do not addresses the issue of low power at low speed. Additionally, the centrifugal type requires speeds of 25,000 to 75,000 RPM to operate, but the limiting speed for passenger car engines is between 5,000 and 7,500 RPM. This indicates that the mechanical drive system must have a speed ratio of 3.3 to 15, depending on the engine and supercharger characteristics.

Automotive producers currently offer only positive displacement superchargers that are engine driven at a fixed ratio by belt/pulley components. A centrifugal supercharger providing similar performance improvements would require a multiple ratio device in the drive system. A multiple ratio centrifugal supercharger would provide significant cost, weight, size and efficiency benefits.

### BRIEF SUMMARY OF THE INVENTION

In one embodiment of the present invention, a multi-speed gear arrangement for use in a centrifugal engine charger is provided. A planetary gear set has a ring gear, at least a first and a second set of planetary gears, and at least a first and a second sun gear. A fixed carrier is provided for the planetary gear set, and the planetary gear set has a rotary input and an output that is linked to a rotor of a centrifugal engine charger.

In a second embodiment of the present invention, a multi-speed gear arrangement for use in a centrifugal engine charger is provided. A planetary gear set has a output to supply torque to a rotor in an engine charger and the planetary gear set has at least a first and a second orientation. The first orientation has a high gear ratio and the second orientation has a low gear ratio. The planetary gear set has a ring gear, at least a first and a second set of planetary gears, at least a first and a second sun gear and a stationary carrier for the planetary gear set. The embodiment also includes a clutching system that can switch the planetary gear set between the two orientations. The first orientation has a torque input at the ring gear which in turn supplies torque to the first set of planetary gears, which in turn supply torque to the first sun gear which drives the rotor of the engine charger. In the second orientation, the torque input is at the second sun gear, which supplies torque to the second set of planetary gears, which in turn supply torque to the first set of planetary gears, which in turn supply torque to the first sun gear which drives the rotor of the engine charger.

In a third embodiment of the present invention, a method for increasing the boost supplied to an internal combustion engine by an engine charger is provided. The method comprises the steps of supplying a planetary gear set with high and low gear ratio orientations and engaging the high gear ratio orientation at engine RPM levels up to a pre-determined level through an electronically controlled clutching system and engaging the low gear ratio at engine RPM levels at or above the pre-determined level. Variable torque is provided to the rotor of the engine charger from an output on the planetary gear set.

### BRIEF DESCRIPTION OF SEVERAL VIEWS OF THE DRAWINGS

FIG. 1 is a plan view of an embodiment of the planetary gear set of the present invention showing the gears engaged when in a high gear ratio orientation;

FIG. 2 is a cross-sectional view of the embodiment shown in FIG. 1 showing the gears engaged when in a high ratio gear orientation;

FIG. 3 is a plan view of the embodiment of the planetary gear set shown in FIG. 1 showing the gears engaged when in a low gear ratio orientation;

FIG. 4 is a cross-sectional view of the embodiment shown in FIG. I showing the gears engaged when in a low ratio gear orientation;

FIG. 5 is a cross-sectional view of an embodiment of the planetary gear set of the present invention showing a clutching system in a high gear ratio orientation;

FIG. 6 is a cross-sectional view of an embodiment of the planetary gear set of the present invention showing a clutching system in a low gear ratio orientation;

FIG. 7 is a table showing a preferred shift event and the relation between engine boost and engine RPM; and

FIG. 8 is a flow chart showing the steps of the method of the present invention.

### DETAILED DESCRIPTION OF THE PREFERRED EMBODIMENTS OF THE INVENTION

The present invention provides a multi-speed gear arrangement for use in a centrifugal engine charger. An engine charger may be either a supercharger or a turbocharger. The only difference in operation between a supercharger and a turbocharger is at the input. A supercharger receives torque from a belt and pulley system connected to the engine. A turbocharger receives torque from a rotor positioned in the exhaust outflow of the vehicle which drives the rotor to provide the torque. The present invention will be described in reference to a supercharger, but can also be used in a turbocharger. All references to the “torque input” to the gear arrangement of the present invention should be construed to include all possible torque inputs to a supercharger or a turbocharger.

The gear arrangement of the present invention allows a supercharger to be designed to be lightweight and fuel efficient while also providing adequate boost to the engine of the vehicle in the form of compressed air. This compressed air allows more air to enter the cylinders of the engine, which in turn allows more fuel to be burned in the cylinder. The gear arrangement of the present invention allows the supercharger to receive torque input from the engine and increase it exponentially to an output to drive the rotor of the supercharger that runs the compressor.

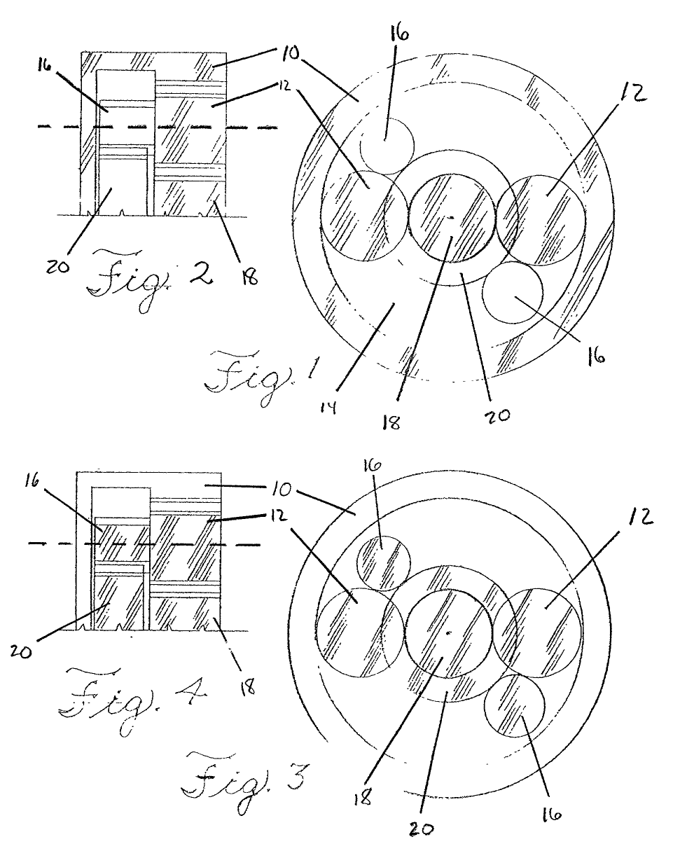

Referring now to FIGS. 1 and 2, a preferred embodiment of the present invention is shown. It is noted that in the figures, the gears are shown in schematic representation and the gear teeth are not shown. Any compatible style and size of gear teeth known in the art may be used in the gears of the present invention. The interaction between the gear teeth of the gears of the present invention will be described in reference to the torque input to each gear. When gears are “engaged” as described in this disclosure, torque is being transferred from one gear to the next. The teeth of the gears are in contact with each other so as to allow one gear to rotate the next. The present invention preferably includes a ring gear 10 with its teeth in contact with a first set of planetary gears 12. The first set of planetary gears 12 preferably comprises two gears disposed and positioned inside the ring gear 10. A stationary carrier 14 is provided and the first set of planetary gears 12 is mounted on the carrier 14.

The present invention also preferably includes a second set of planetary gears 16 mounted on the carrier 14. The first set 12 and the second set 16 of planetary gears preferably share an axis, as shown in the cross-sectional views of FIGS. 2 and 4. The present invention also preferably includes a first sun gear 18 and a second sun gear 20 mounted within the ring gear 10. The first sun gear 18 preferably has a smaller radius than the second sun gear 20. The planetary gear set shown in the Figures allows the present invention to increase the rotational energy supplied in the form of RPM from the engine at the input to the planetary gear set and utilize it to drive the rotor 22 of the supercharger at the output. The RPM output of the planetary gear set is significantly higher than the RPM input.

Referring now to FIGS. 1, 2 and 5, a preferred embodiment of the present invention is shown with a clutching system in place. In these Figures, the present invention is shown in a high gear ratio mode, such that the rotational energy from the engine is increased more drastically than when the present invention is configured in a low gear ratio mode. In the high gear ratio mode, the gear ratio can be calculated by dividing the number of gear teeth on the ring gear 10 by the number of gear teeth on the first sun gear 18. In FIG. 1, the operating gears are shown shaded to differentiate them from the non-operating gears. The preferred embodiment of the present invention preferably implements a clutching system to switch the gear arrangement between the high gear ratio orientation and the low gear ratio orientation. As shown in FIGS. 5 and 6, this clutching arrangement comprises an electromagnetic clutch in the form of a coil 24 to which current can be supplied. Preferably, a plate of high friction material 26 such as sintered metal or carbon fiber is positioned such that it can come in contact with a section 28 of the ring gear 10. The friction material 26 is mounted in bearings 30 to allow it to rotate freely. The friction material 26 allows the ring gear 10 to receive torque from the pulley 32 connected to the engine (not shown). When the coil 24 is activated, an axial spline 36 allows the section 28 of the ring gear 10 to move into contact with the friction material 26. The section 28 of the ring gear 10 compresses the friction material 26 against the pulley 30 and torque is transferred from the pulley 30 to the ring gear 10. The increased speed difference when the ring gear 10 is engaged with the pulley 30 causes a one-way clutch 34 to overrun and disengage the second sun gear 20 from the input.

In the high gear ratio orientation shown in FIGS. 1, 2 and 5, gears of the gear arrangement that are operating to transfer torque are shown shaded to differentiate them from the non-operating gears. Torque is supplied to the ring gear 10 from the pulley 32. The ring gear 10 in turn is engaged to the first set of planetary gears 12 and torque is transferred from the ring gear 10 to the first set of planetary gears 12. The first set of planetary gears 12 is engaged to the first sun gear 18 to transfer torque to the first sun gear 18. The first sun gear 18 is the output to the rotor 22 of the supercharger.

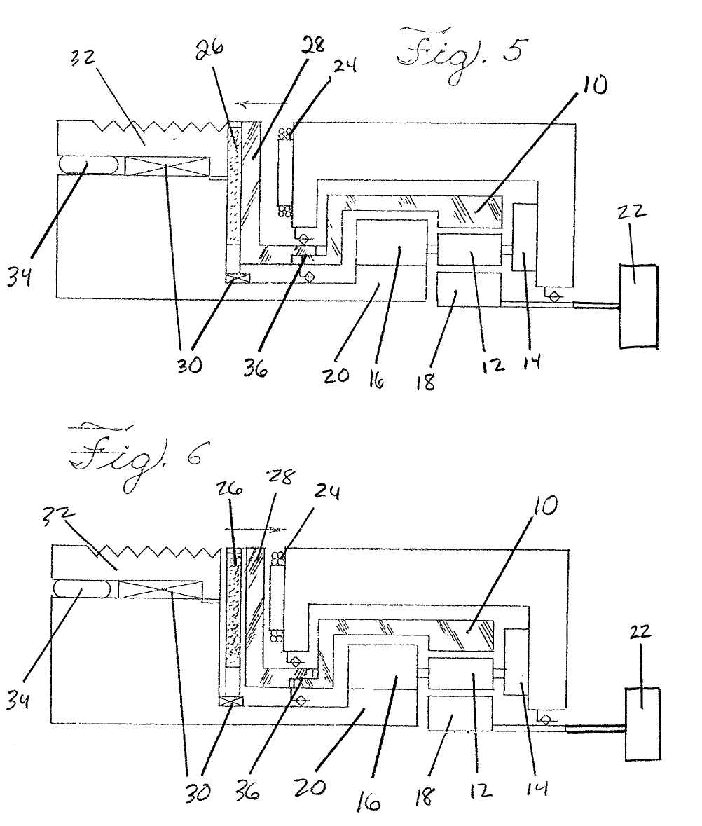

In the low gear ratio mode shown in FIGS. 3, 4 and 6, no current is supplied to the coil 24 and the section 28 of the ring gear 10 is out of contact with the friction material 26. The one-way clutch 34 is in its resting position, and the second sun gear 20 is engaged to the pulley 32. In the low gear ratio orientation, torque is supplied from the pulley 32 to the second sun gear 20 which is engaged to the second set of planetary gears 16. The second set of planetary gears 16 supplies torque to the first set of planetary gears 12. The first set of planetary gears 12 supplies torque to the first sun gear 18. The first sun gear 18 is the output to the rotor 22 of the supercharger. In the low gear ratio mode, the gear ratio can be calculated by dividing the number of gear teeth on the second sun gear 20 by the number of gear teeth on the first sun gear 18.

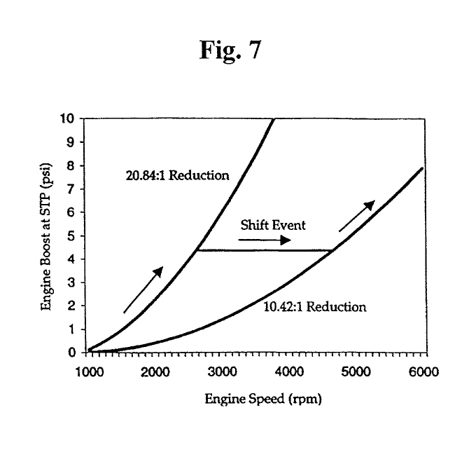

Preferably, the low speed orientation is the default orientation for the gear arrangement. The low speed orientation still provides an adequate boost to the engine from the supercharger, but in the case of an electrical failure that causes the electromagnetic clutch to fail while in the high speed orientation, the gears return to the low speed orientation to avoid any damage to the gears. This fail-safe feature also prevents damage to the bearings, shafts and impeller of the supercharger due to overspeed. The clutching system comprising the coil 24 and the one-way clutch 34 is preferably electronically controlled so that the operator does not have to manually control the shifting event. The high gear ratio orientation is preferably activated at engine RPM up to about 2700 RPM. This allows the high gear ratio orientation to provide a higher level of RPM to the supercharger through the planetary gear set when the engine RPM is lower. The higher RPM level of the supercharger provides a greater boost to the engine. Once the engine reaches about 2700 RPM, a shift event occurs and the electromagnetic coil 24 no longer receives current. The axial spline 36 allows the section 28 of the ring gear 10 to move out of contact with the friction material 26 and the one-way clutch reengages the second sun gear 20. For RPM levels above about 2700 RPM, the low gear ratio orientation remains engaged and a lower boost is provided to the engine from the supercharger. FIG. 7 shows a typical preferred shift event to demonstrate the relation between engine boost (in pounds per square inch), engine RPM, and the shift event. Depending on the characteristics of the engine and the planetary gear set, single or multiple shift events may be dictated to optimize performance. It is also possible to change the characteristics of the clutching system so that the shift event occurs at RPM levels other than 2700 RPM. The gear ratios shown in FIG. 7 are meant to be exemplary, and may be adjusted according to the desired boost level for the engine.

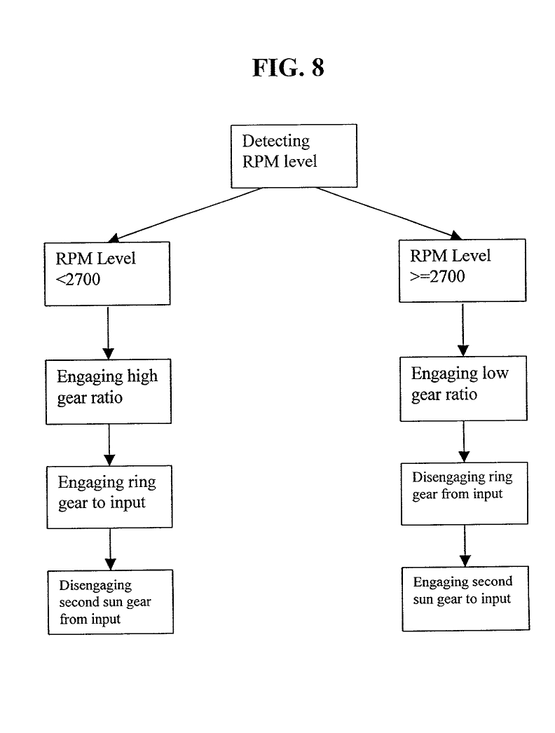

The present invention also provides a method for increasing the boost supplied to an internal combustion engine by a supercharger through the steps shown in FIG. 8. A planetary gear set is provided that is capable of efficiently using the RPM input supplied by the engine to provide a substantially higher level of RPM to the rotor 22 of the supercharger. The planetary gear set may be adjusted between a high gear ratio orientation and a low gear ratio orientation. The method includes the step of engaging the high gear ratio orientation at engine RPM levels up to a pre-determined engine RPM level through an electronically controlled clutching system. An example of such a clutching system is a one-way clutch 34 and an electromagnetic coil 24, as described in the previous embodiment. The electronically controlled clutching system moves the ring gear 10 into engagement with the torque input and moves the second sun gear 20 out of engagement from the torque input. The method further includes the step of engaging the low gear ratio orientation at RPM levels above the predetermined RPM level referenced above. An example of a preferred engine RPM level for the switch from the high gear ratio orientation to the low gear ratio orientation is about 2700 RPM, but this number could be adjusted depending on the requirements of the engine and the desired fuel efficiency. This electronically controlled clutching system in tandem with the planetary gear set allows the present method to provide variable torque to the rotor 22 of the centrifugal supercharger to vary the amount of boost supplied to the engine.

It should be noted that there could be a wide range of changes made to the present invention without departing from its scope. More sets of planetary gears could be utilized and additional gear sets could allow more than two speeds to be realized in the system. The size of the planetary gears could be adjusted as well as the size of the sun gears. The number of teeth on the gears may be adjusted depending on the desired gear ratio and desired amount of boost. The clutching system can also be comprised of different clutching mechanisms known in the art. Additionally, this same planetary gear set can be used to power additional vehicle subsystems requiring power such as camshafts, power steering pumps, alternators or compressors. Thus, it is intended that the foregoing detailed description be regarded as illustrative rather than limiting and that it be understood that it is the following claims, including all equivalents, which are intended to define the scope of the invention.

What is claimed is:

1. A multi-speed gear arrangement for use in a centrifugal engine charger, said multi-speed gear arrangement comprising:
a planetary gear set having a ring gear, at least a first and a second set of planetary gears, at least a first and a second sun gear; and
a fixed carrier for said planetary gear set, said set having a rotary input and an output linked to a rotor of said centrifugal engine charger.

2. The multi-speed gear arrangement of claim 1, wherein said planetary gear set has at least a first orientation and a second orientation.

3. The multi-speed gear arrangement of claim 2, wherein said first orientation is a high gear ratio orientation and includes a torque input at said ring gear.

4. The multi-speed gear arrangement of claim 3, wherein said second orientation is a low gear ratio orientation and includes a torque input at said second sun gear.

5. The multi-speed gear arrangement of claim 4, wherein said first and said second orientations include a torque output at said first sun gear.

6. The multi-speed gear arrangement of claim 5, wherein said first sun gear drives a rotor for an engine charger in an internal combustion engine.

7. The multi-speed gear arrangement of claim 6, wherein said engine charger is a turbocharger, and said torque input is from a rotor driven by the exhaust outflow from the engine of the vehicle.

8. The multi-speed gear arrangement of claim 6, wherein said engine charger is a supercharger, and said torque input is from a pulley receiving torque from the engine of the vehicle.

9. The multi-speed gear arrangement of claim 8, wherein said output to said rotor in said first orientation allows said rotor to spin at higher rates than when said gear arrangement is in said second orientation.

10. The multi-speed gear arrangement of claim 9, wherein said first and said second orientations allow for variable boost to be supplied from the supercharger to the engine.

11. The multi-speed gear arrangement of claim 10, wherein in said first orientation, said ring gear drives said first set of planetary gears and said first set of planetary gears drives said first sun gear.

12. The multi-speed gear arrangement of claim 11, wherein in said second orientation, said second sun gear drives said second set of planetary gears, said second set of planetary gears drives said first set of planetary gears, and said first set of planetary gears drives said first sun gear.

13. The multi-speed gear arrangement of claim 12, wherein the speed increase supplied by said gear arrangement to said rotor in said first orientation is a function of the number of gear teeth on said ring gear divided by the number of gear teeth on said first sun gear and the speed increase supplied in said second orientation is a function of the number of gear teeth on said second sun gear divided by the number of gear teeth on said first sun gear.

14. The multi-speed gear arrangement of claim 13, wherein a clutching system is utilized to change the input and the orientation of said planetary gear set.

15. The multi-speed gear arrangement of claim 14, wherein said clutching system comprises an electromagnetic clutch and a one-way clutch.

16. The multi-speed gear arrangement of claim 15, wherein said electromagnetic clutch comprises an electromagnetic coil to which current can be supplied.

17. The multi-speed gear arrangement of claim 16, wherein when current is supplied to said coil, said ring gear is engaged to said input.

18. The multi-speed gear arrangement of claim 17, wherein said one-way clutch disengages said second sun gear from said input when said ring gear is engaged to said input.

19. The multi-speed gear arrangement of claim 18, wherein said planetary gear set is switched between said second orientation and said first orientation at an engine RPM level of approximately 2700 RPM.

20. A multi-speed gear arrangement for use in a centrifugal engine charger, said multi-speed gear arrangement comprising:
a planetary gear set having an output to supply torque to a rotor in an engine charger, said planetary gear set having at least a first and a second orientation, said first orientation having a high gear ratio and said second orientation having a low gear ratio, said planetary gear set having a ring gear, at least a first and a second set of planetary gears, at least a first and a second sun gear and a stationary carrier for said planetary gear set; and
a clutching system capable of switching said planetary gear set between said first and said second orientations, said first orientation having a torque input to said ring gear which in turn supplies torque to said first set of planetary gears, which in turn supply torque to said first sun gear which drives said rotor of said engine charger, and said second orientation having a torque input to said second sun gear which in turn supplies torque to said second set of planetary gears, which in turn supply torque to said first set of planetary gears, which in turn supply torque to said first sun gear which drives said rotor of said engine charger.

21. The multi-speed gear arrangement of claim 20, wherein said clutching system comprises an electronically controlled clutching system wherein the activation of an electromagnetic coil causes said ring gear to be engaged to said input at a pre-determined engine RPM level and said engagement of said ring gear causes a one-way clutch to disengage said second sun gear from said input.

22. The multi-speed gear arrangement of claim 21, wherein upon deactivation of said coil, said ring gear disengages from said input and said one-way clutch reengages said second sun gear to said input.

23. A method for increasing the boost supplied to an internal combustion engine by an engine charger, said method comprising the steps of:
supplying a planetary gear set comprising a first and a second set of planetary gears, and having a high gear ratio orientation and a low gear ratio orientation;
engaging said high gear ratio orientation at engine RPM levels up to a pre-determined RPM level through an electronically controlled clutching system;
engaging said low gear ratio orientation at engine RPM levels at or above said pre-determined engine RPM level; and
providing variable torque to a rotor of said engine charger from an output from said planetary gear set.

24. The method of claim 23, wherein said electronically controlled clutching system moves said ring gear into engagement with a torque input and moves said second sun gear out of engagement from said torque input to engage said high gear ratio.

25. The method of claim 24, wherein said electronically controlled clutching system disengages said ring gear from said input and reengages said second sun gear to said input to engage said low gear ratio.

26. The method of claim 25, wherein said output is said first sun gear.

27. The method of claim 26, wherein said electronically controlled clutching system comprises an electromagnetic coil and a one way clutch.

28. The method of claim 27, wherein said step of engaging said ring gear with said input is performed through activation of said electromagnetic coil.

29. The method of claim 28, wherein said step of reengaging said second sun gear to said input is performed by said one-way clutch.

30. The method of claim 29, wherein said pre-determined engine RPM level is approximately 2700 RPM.
